(19) United States
(12) Patent Application Publication
(10) Pub. No.: US 2004/0126637 A1
(43) Pub. Date: Jul. 1, 2004

(54) Process for producing coated tubes, and fuel cell system constructed using tubes which have been coated using this process

(76) Inventors: Gerard Barbezat, Opfikon (CH); Hans Peter Buchkremer, Heinsberg (DE); Robert Fleck, Adelsdorf (DE); Michael Loch, Wehr (DE); Norbert Heribert Menzler, Juelich (DE); Detlev Stoever, Niederzier (DE)

Correspondence Address: HARNESS, DICKEY & PIERCE, P.L.C., P.O.BOX 8910, RESTON, VA, 20195, US

(21) Appl. No.: 10/443,881

(22) Filed: May 23, 2003

(30) Foreign Application Priority Data
May 23, 2002 (DE) 10222855.8

(51) Int. Cl. H01M 8/12; B05D 5/12

(52) U.S. Cl. 429/31; 427/115; 429/32

(57) ABSTRACT

A combination of a plasma spraying process and a vacuum slip casting process is carried out. By combining these two processes, which can each be carried out without difficulty, it is surprisingly possible to achieve good electrolyte layers. Therefore, it is possible to construct a fuel cell system using coated tubes in a bundled arrangement, the tubes being electrically connected in series and operated as a fuel cell generator in power units of between 100 kW and a few MW.

The present application hereby claims priority under 35 U.S.C. §119 on German patent application number DE 10222855.8 filed May 23, 2002, the entire contents of which are hereby incorporated herein by reference.

### FIELD OF THE INVENTION

The invention generally relates to a process for producing coated tubes in order to construct a fuel cell structure. The structure preferably includes layers of individual tubes arranged on top of one another and flow passages which are integrated in or between the tubes. In addition, the invention also generally relates to an associated fuel cell system having a multiplicity of fuel cells which are of tubular design. They preferably form a fuel cell structure including layers of individual coated tubes arranged on top of one another with integrated flow passages.

### BACKGROUND OF THE INVENTION

A high-temperature (HT) fuel cell includes a solid oxide electrolyte which is arranged between two porous electrodes, the electrodes and the electrolyte being produced as functional layers in a suitable sequence. The function of the solid oxide HT fuel cell is described in detail, for example, in VIK-Berichte, No. 214, November 1999 “Brennstoffzellen” [Fuel Cells] on page 49 ff. for what is known as the tubular concept and on page 54 ff. for the planar embodiment. In particular, the tubular concept with a tubular fuel cell structure and interconnector between the individual tubes is considered to have a high potential for practical applications.

In the tubular high-temperature fuel cell, the layer sequence is generally as follows: cathode, electrolyte, anode, the cathode being formed by the tube substrate, which bears the further functional layers, in particular the electrolyte. The electrolyte generally consists of zirconium oxide (ZrO₂) doped with 7 to 12 mol % of yttrium oxide (Y₂O₃). One of the demands imposed on the electrolyte is that it be leaktight with respect to fuel gases and air as oxidizing agent. To avoid a high internal resistance and to achieve a high level of efficiency, the thickness of the electrolyte layer should be as thin as possible, and specifically, in particular, no more than 20 to 40 μm.

A wide range of processes are known from the prior art for application of the solid-state electrolyte layer. Hitherto, in the tubular fuel cell, the zirconium oxide electrolyte (ZrO₂) which is doped with yttrium oxide (Y₂O₃) has been applied to a porous cathode substrate using an EVD (Electrochemical Vapor Deposition) process.

The latter process has proven successful and can be used in particular to form a dense coating even on rough surfaces and complex geometries. However, the EVD processes is so expensive that hitherto commercial exploitation of the technology has been prevented by the high costs incurred.

Further processes for producing dense electrolyte layers on porous cathode or anode substrates are the VSC (Vacuum Slip Casting) process, which is described in detail in DE 196 09 418 A (=EP 0 890 195 B1), or the LPPS thin film (Low-Pressure Plasma Spraying Thin Film) process.

For the VSC process, which is also known as vacuum slip casting, particularly in the case of planar electrodes, a suspension is applied to the substrate, this suspension containing fractions of solid consisting of the solid-state electrolyte material. Excess solvent is discharged by generating a vacuum on the opposite side of the porous electrode from the suspension. The suspension includes coarse and fine solids fractions, the coarse solids fractions firstly blocking the pores in the electrode and ensuring good bonding between electrolyte layer and electrode. The fine fractions are then deposited on the large fractions. The solid layer is dried and then sintered.

The latter VSC coating process requires subsequent sintering at high temperatures. This process can be used to deposit electrolyte layers of, for example, 3 to 30 μm without cracks on corresponding substrates. Typical solids concentrations in the electrolyte suspension vary between 5 and 15% by mass. The layer thickness can be adjusted by means of the coating duration or by means of the suspension quantity and its solids concentration.

The LPPS thin-film process which is also mentioned is known in detail from U.S. Pat. No. 5,853,815 A. This process uses a plasma jet at a lower pressure, preferably less than 10 mbar, than is the case with the conventional plasma process under reduced pressure (LPPS, VPS or LVPS). Unlike with the conventional processes, this process forms a plasma jet which is widened transversely and has a defocusing action on a powder jet which is injected into the plasma by a carrier gas. Within a period of time which is short in the context of thermal coating processes, it is possible for a large area to be covered by the plasma jet which carries the coating material in dispersed form.

An LPPS thin-film process of this type, which uses plasma jet to substrate distances of, for example, up to 2.5 m, results in uniform, very thin layers. However, to form a coating of a defined density, the coating has to be built up using a large number of individual applications. A suitable coating material consists of mixtures of powder particles for which the mean particle diameter is preferably <50 μm. Each particle whose diameter is not significantly greater than the mean diameter is partially or completely melted in the plasma jet, so that when the hot particles impinge on a substrate it is possible to form a layer which has a defined density and thickness. The density or porosity of the microscopic structure of the sprayed-on layer can be adjusted by means of the spraying and powder parameters selected.

### SUMMARY OF THE INVENTION

Working on this basis, it is an object of an embodiment of the invention to provide a process for producing a dense electrolyte which preferably combines at least one of the advantages of the previous processes with others and in particular, can be implemented at low cost. In addition, it is intended to provide an associated fuel cell system.

An embodiment of the invention substantially comprises a combination of the LPPS thin-film process and the VSC process. Although both processes are known individually from the prior art, their specific, mutually adapted combination is not known. Combining these two methods in this way has proven advantageous for the application of the electrolyte to the porous electrode of a high-temperature fuel cell. In the first step, a homogenous layer which extends over the entire substrate and has reproducible porosities and a uniform layer thickness is applied to the entire surface by means of a LPPS thin-film process. This layer has to be sintered, which then takes place in accordance with the prior art.

In an embodiment of the invention, the LPPS thin-film process is followed, in a second step—instead of the sintering step—first of all by the vacuum slip casting, as a simple, inexpensive process, in which what are known as nanometer or micrometer powders, i.e. in the nanometer to micrometer range, with or without sintering additives in a suspension of solid particles are used, depending on the porosity of the coating produced using the LPPS thin-film process. The suspension infiltrates the LPPS layer and accumulates the solid particles in the porosity of the layer.

In the context of an embodiment of the invention, the LPPS process operates at mean substrate temperatures, in particular 200° C. to 400° C., at which the process reliability is advantageously high. The structure of the sprayed layer can be influenced in a targeted way by adjusting the coating parameters. The LPPS thin-film process is used to build up a layer structure comprising flat disk-like molten YSZ particles which have an attracted leak rate as a layer of, for example, q₀=(4−8)·10⁻² mbar·l/s/cm². This framework of electrolyte material with a defined structure and a high density (90 to 95%) can be densified further by means of a sintering step carried out at high temperatures.

The advantage of the combination of processes according to the invention resides in particular in the fact that a layer produced using the LPPS thin-film process, after infiltration by means of the VSC process, can be densely sintered in a subsequent sintering step at lower temperatures than those used with other processes. By way of example, temperatures of only 1250° C. and sintering times of only 3 h are sufficient. Production without a further additional sintering step may also be possible by means of what is known as cofiring, i.e. a joint sintering step with the anode, at temperatures between 1250° C. and 1300° C.

In practice, the process has been tested for coating cathode tubes with an oxide-ceramic electrolyte in order for the tubes to be used as tubular high-temperature fuel cells, and leak rates of q≦2.3·10⁻4 mbar·l/s/cm² were achieved. It is possible to coat a multiplicity of tubes simultaneously.

### BRIEF DESCRIPTION OF THE DRAWINGS

Further details and advantages will emerge from the following description of figures illustrating exemplary embodiments with reference to the drawings in conjunction with the patent claims. In the drawings:

FIG. 1 shows a flowchart illustrating the production of coatings,

FIG. 2 shows a layer structure produced by the LPPS thin-film process,

FIG. 3 shows a layer structure produced by the VSC process,

FIG. 4 shows a layer structure which has been produced by an LPPS thin-film process combined with VSC, after sintering, and

FIG. 5 shows a fuel cell system comprising a bundle of tubular SOFC fuel cells with coatings as shown in FIG. 4, produced using the process described with reference to FIG. 1.

### DETAILED DESCRIPTION OF THE PREFERRED EMBODIMENTS

Known commercial installations are used to produce LPPS thin films, on the one hand, and VSC layers, on the other hand. The present description will not deal with the structure of these installations in detail, but rather reference is made to the general prior art cited in the introduction. In particular, WO 02/19455 A1, in the name of the present applicant, discloses the use of the LPPS thin-film process for producing fuel cell structures.

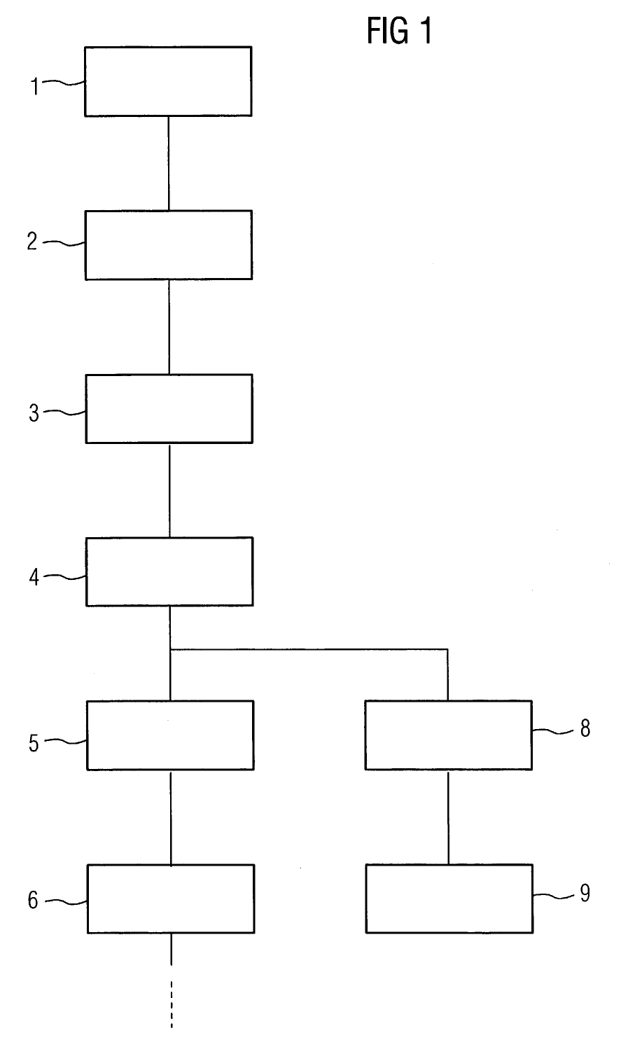

In the flowchart shown in FIG. 1, box 1 denotes the introduction of tubes into a reactor chamber of a coating installation. The coating installation is described, for example, in U.S. Pat. No. 5,853,815 A and is distinguished by a particularly large reaction space in which the parts which are to be coated are situated at a sufficient distance from the plasma generation source. According to box 2, what is known as the LPPS thin-film process is carried out, in which a first layer, as an interlayer which deliberately has a high porosity and has a defined pore size/pore structure, is produced on the tubes. According to box 3, the tubes are discharged from the coating installation and introduced into a vacuum slip casting installation. The VSC process is then carried out in accordance with box 4. In this process, the layer which has been produced using the LPPS thin-film process and the porosity of which forms a framework for the vacuum slip casting, is completed in such a manner that the porosity is filled in a targeted manner. As a result, the surface of the interlayer which was produced first is altered and sealed to a certain extent.

According to box 5, the coated tubes are discharged or introduced into a sintering furnace or the like, with subsequent sintering in accordance with box 6. Alternatively, in accordance with box 8, it is also possible for the anode for the fuel cell structure to be applied as a further functional layer to the tubes which have been coated with electrolyte. In a special step as indicated by box 9, this is followed by what is known as co-firing, i.e. simultaneous sintering of the electrolyte layer and the anode layer.

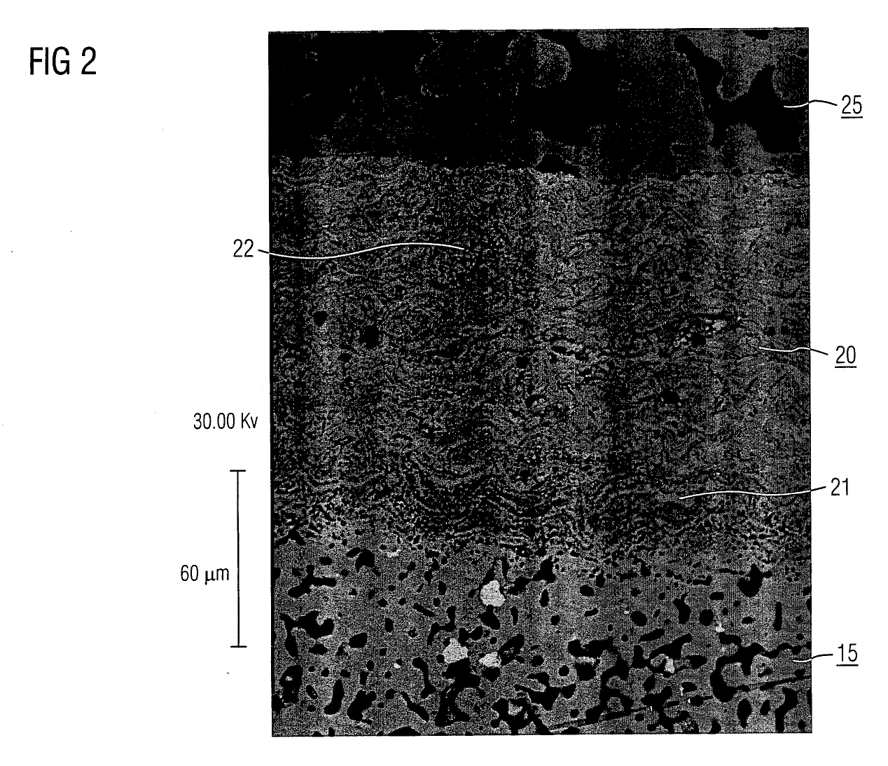

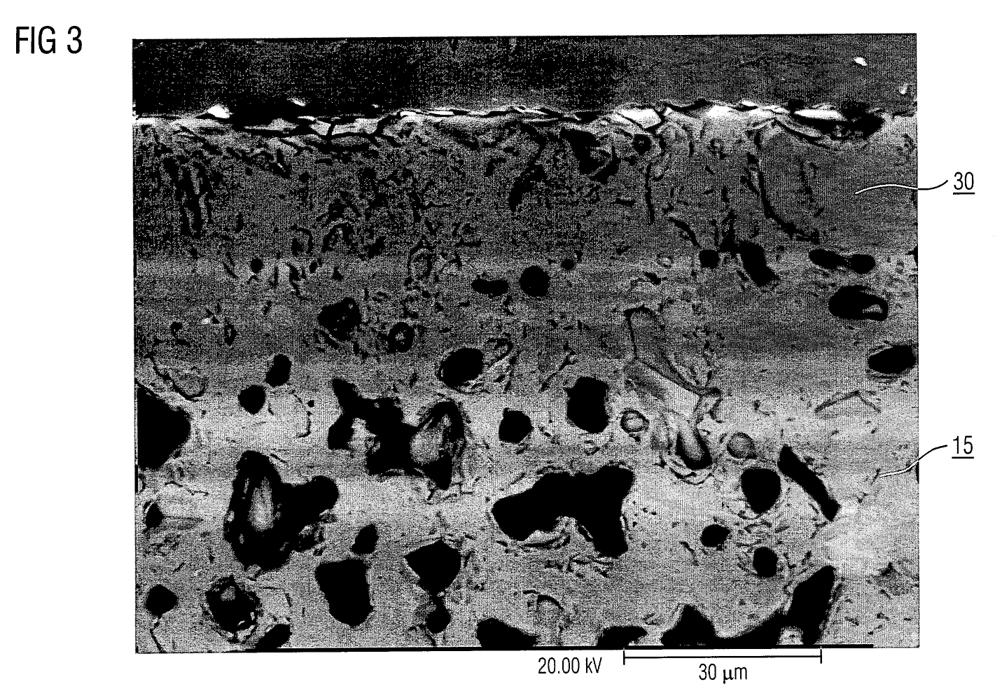

FIGS. 2 and 3 show SEM (Scanning Electron Microscope) images of coatings produced using the processes according to the prior art, the suitability of which for use in high-temperature fuel cells with ceramic electrolytes has been tested by the applicant.

In FIG. 2, 20 denotes a layer produced using the LPPS thin-film process. In detail, the layer 20 has been applied to a substrate 15, specifically to the cathode of a tubular fuel cell arrangement. On the layer 20 there is a further functional layer 25, specifically, for the coating intended to be used in fuel cells, the anode of the fuel cell structure.

FIG. 2 also shows the electrolyte structure with inhomogeneities 21 and 22, of which the inhomogeneities 21 are pores and the inhomogeneities 22 are shell-like boundary regions. In particular the shell-like regions 22 are an inevitable result of the system used for the LPPS thin-film process, since the ceramic materials are deposited in succession in the form of flat disks as droplets of liquid.

To complete the coated tubes for their intended use for fuel cells, a layer structure as shown in FIG. 2 would require relatively high temperatures during the sintering which usually follows the coating, as well as further specific treatment steps. This therefore requires a considerable level of outlay.

FIG. 3 illustrates a layer 30, which has been produced by vacuum slip casting, on a substrate 15. At first glance, a layer of this type appears to have good properties. However, a drawback is that during sintering of the substrate/layer assembly, surface unevenness forms in the finished electrolyte layer, since during the heat treatment the slip casting material fills the inhomogeneities in the substrate.

In the combination process according to an embodiment of the invention, the latter, inherently undesirable property of the slip casting material is deliberately utilized. In accordance with the flowchart shown in FIG. 1, therefore, first of all the LPPS thin-film process is used to produce an interlayer having the properties described; this layer, which per se is unsuitable for the intended application, now merely serves as a framework for the further coating. The framework of the interlayer is therefore the base or substrate used for further coating by means of the VSC process, the porosity in the framework being deliberately filled by the VSC material comprising nanometer and/or micrometer powders.

Therefore, the latter procedure improves the layer produced by way of the LPPS thin-film process in such a manner that it becomes sufficiently gastight. If suitable materials are used, an ion-conducting layer of this type is eminently suitable as an electrolyte for solid oxide high-temperature fuel cells.

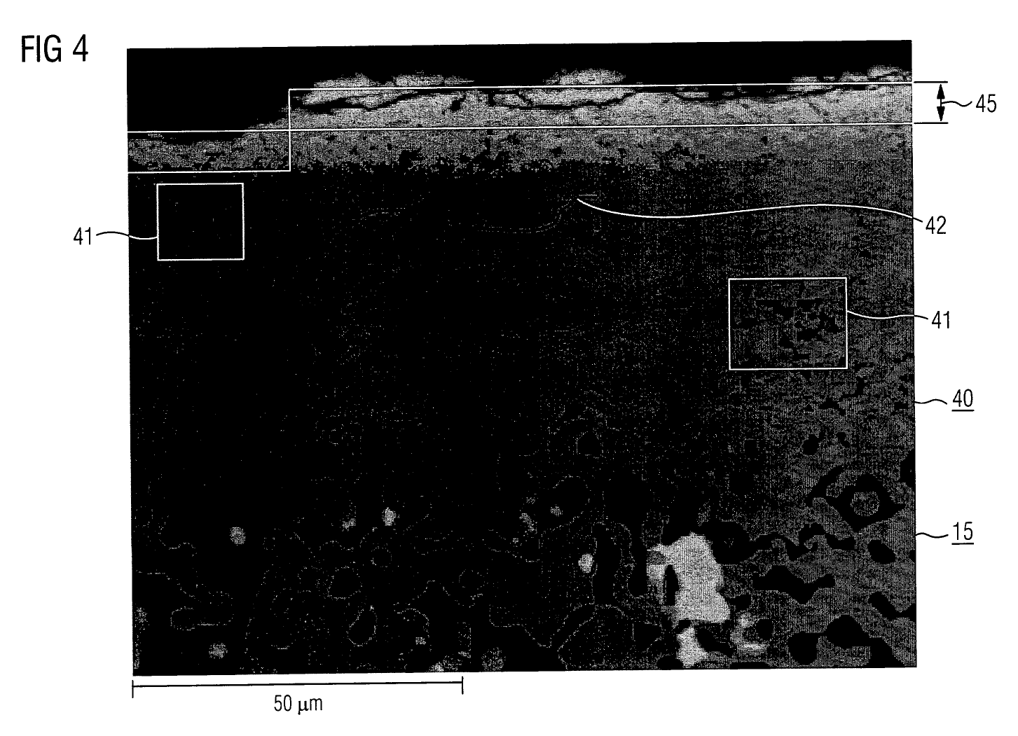

FIG. 4 shows an SEM image of a layer 40 produced using the new combination process. The figure shows regions 41 with a relatively high but closed porosity and also clearly illustrates the flat disk structure of the LPPS-sprayed electrolyte layer 40.

After sintering, the result, in the upper region of the layer 40, is a densified infiltration region 45 of the electrolyte material which has been applied by VSC in the electrolyte 40 produced by the LPPS thin film process. The sintering seals the coating produced by the two-stage coating process to a certain extent, with surprisingly good properties being achieved in the finished layer.

A significant feature of the coatings produced in this way is that they are ion-conducting and sufficiently gastight for use as functional layers in high-temperature fuel cells. Therefore, these layers can be used as an electrolyte for the fuel cells. At 1000° C., the conductivity of the layers is approximately 0.1 S/m (Siemens/meter), and the gastightness is less than 2.3 10⁻⁴ mbar·l/s/cm².

It is particularly advantageous for use for tubular HT fuel cells for the layers to be able to fill undercuts which inevitably occur in the structure of the tubular fuel cells. This is particularly important for what is known as the interconnector for electrical connection of the cathode, by which in particular individual tubes of the fuel cell structure are connected. Consequently, a fuel cell structure with a bundled arrangement of the tubes, which are electrically connected partly in series and partly in parallel, can be produced from individual coated tubes, it being possible for the arrangement to be operated as an electric generator in power units of between 100 kW and a few (such as at least two, for example) MW.

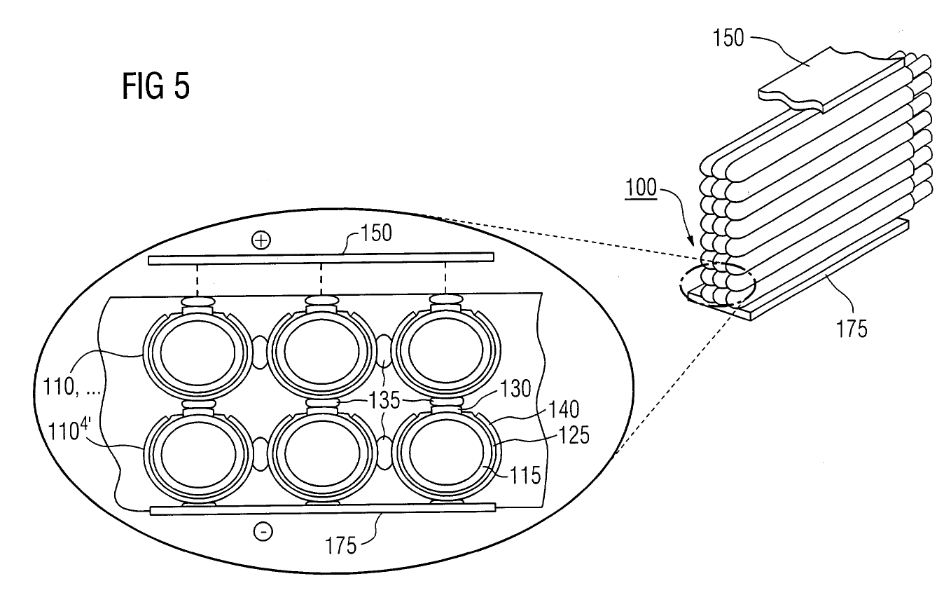

FIG. 5 illustrates a fuel cell system having a tubular cell bundle 100 which comprises a multiplicity of tubular fuel cells 110, 110′, 110″, . . . , as is known from the “VIK-Berichte” literature reference cited in the introduction. Now, however, the individual tubes 110, 110′, 110″, . . . have been provided with coatings as shown in FIG. 4 by use of the combined LPPS+VSC method described with reference to FIG. 1. In accordance with FIG. 4, reference symbol 115 denotes a cathode substrate corresponding to substrate 15, which forms the air electrode of the fuel cell and surrounds the air stream, 140 denotes the electrolyte layer according to an embodiment of the invention which has been applied to it, and 130 denotes an anode layer, which faces the fuel gas, as fuel-gas electrode. In each tubular fuel cell 110, 110′, 110″, . . . , the airstream flows through the tubular cathode tube while the fuel gas is supplied together from the outside.

It can be seen from FIG. 5 that an interconnector 130 which is arranged on the cathode substrate along an individual tube 110, 110′, 110″, . . . connects the cathode 115 of a first fuel cell to the anode 125 of a second fuel cell, so that a series circuit is produced. The tubular cells 110, 110′, 110″, . . . , which are conductively connected to one another at their circumference by way of nickel felts 135, produce a parallel circuit. A common cathode plate and a common anode plate 175 are present on the outer side for all the tubular cells 110, 110′, 110″, . . . of the fuel cell bundle 100.

To obtain voltages and currents which are useful for technical applications, the individual tubular fuel cells are combined into bundles by series and parallel circuits by means of nickel coatings and in particular by way of flexible nickel felts 140. A typical bundle comprises eight series-connected cells, with three such rows being connected in parallel. 150 denotes a higher-level cathode plate and 175 denotes a higher-level anode plate, which are each electrically connected to the individual cathode substrates and the individual anode layers.

The fuel cell bundles are connected to form submodules, and the submodules are connected to form modules. A 100 KW installation comprises four such bundles, geometrically in a row, and twelve bundles, arranged in parallel, so that the installation comprises 1152 individual tubes. However, in electrical terms all the fuel cell bundles are connected in series.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A process for producing coated tubes for constructing a fuel cell structure, the structure comprising layers of individual tubular fuel cells arranged on top of one another, with flow passages integrated at least one of in and between the tubes, the process comprising the steps of:
applying a first layer to the tubes by a plasma spraying process using a plasma jet which has a defocusing action on an injected powder jet; and
applying a further coating to the first layer by a vacuum slip casting process, this further coating altering the first layer in such a manner that it has properties which are sufficient for the coated tubes to be used as a fuel cell.

2. The process as claimed in claim 1, wherein the tubes are coated at least one of individually and jointly.

3. The process as claimed in claim 1, wherein the plasma spraying process is an LPPS thin-film process.

4. The process as claimed in claim 1, wherein the first layer is impregnated using the vacuum slip casting process.

5. The process as claimed in claim 1, wherein the layers are sintered on the tubes.

6. The process as claimed in claim 1, wherein the tubes are pretreated prior to the coating, resulting in bonding of the coating to the tube surfaces.

7. The process as claimed in claim 1, wherein, after the coating, the tubes are assembled to form a bundle which forms the fuel cell structure.

8. A fuel cell system, comprising:
a plurality of fuel cells of tubular design, each fuel cell including individual tubes provided with a coating; and
interconnectors, wherein the multiplicity of fuel cells and interconnectors form a fuel cell structure comprising bundled tubes with flow passages integrated at least one of in and between the tubes, wherein the coating includes a first layer applied to the tubes by a plasma spraying process and a further coating applied to the first layer by a vacuum slip casting process.

9. The fuel cell system as claimed in claim 8, wherein the conductivity of the layers at 1000° C. is approximately 0.1 Siemens/Meter.

10. The fuel cell system as claimed in claim 9, wherein the gastightness is q<2.3·−10⁻⁴ mbar·l/s/cm².

11. The fuel cell system as claimed in claim 8, wherein the coatings fill undercuts in the structure of the tubular fuel cells.

12. The fuel cell system as claimed in claim 11, wherein the fillings are present at the interconnectors of the fuel cells.

13. The fuel cell system as claimed in claim 8, wherein the coated tubes, in a bundled arrangement, are electrically connected in series and in parallel in groups and form submodules, and wherein modules constructed from the submodules are operated as a fuel cell generator in power units of between 100 kW and at least two MW.

14. The process as claimed in claim 2, wherein the tubes are coated in a common vessel.

15. The process as claimed in claim 1, wherein the tubes are pretreated by sand-blasting prior to the coating, resulting in bonding of the coating to the tube surfaces.

16. The process as claimed in claim 2, wherein, after the coating, the tubes are assembled to form a bundle which forms the fuel cell structure.

17. The process as claimed in claim 3, wherein, after the coating, the tubes are assembled to form a bundle which forms the fuel cell structure.

18. The process as claimed in claim 4, wherein, after the coating, the tubes are assembled to form a bundle which forms the fuel cell structure.

19. The process as claimed in claim 5, wherein, after the coating, the tubes are assembled to form a bundle which forms the fuel cell structure.

20. The process as claimed in claim 6, wherein, after the coating, the tubes are assembled to form a bundle which forms the fuel cell structure.

21. The fuel cell system as claimed in claim 8, wherein the plasma spraying process is one wherein a plasma jet which has a defocusing action on an injected powder jet, is used.

22. The fuel cell system as claimed in claim 9, wherein the coated tubes, in a bundled arrangement, are electrically connected in series and in parallel in groups and form submodules, and wherein modules constructed from the submodules are operated as a fuel cell generator in power units of between 100 kW and at least two MW.

23. The fuel cell system as claimed in claim 10, wherein the coated tubes, in a bundled arrangement, are electrically connected in series and in parallel in groups and form submodules, and wherein modules constructed from the submodules are operated as a fuel cell generator in power units of between 100 kW and at least two MW.

24. The fuel cell system as claimed in claim 11, wherein the coated tubes, in a bundled arrangement, are electrically connected in series and in parallel in groups and form submodules, and wherein modules constructed from the submodules are operated as a fuel cell generator in power units of between 100 kW and at least two MW.

25. The fuel cell system as claimed in claim 12, wherein the coated tubes, in a bundled arrangement, are electrically connected in series and in parallel in groups and form submodules, and wherein modules constructed from the submodules are operated as a fuel cell generator in power units of between 100 kW and at least two MW.

26. The fuel cell system of claim 8, wherein the coating is ion-conductive and sufficiently gastight for it to be used as an electrolyte of the fuel cells.

27. A fuel cell generator including the fuel cell system of claim 8.

28. A fuel cell generator including the fuel cell system of claim 9.

29. The fuel system of claim 8, wherein the coated tubes are configured in a bundled arrangement, the tubes being electrically connected in series.

30. The fuel cell system of claim 29, wherein the coating is ion-conductive and sufficiently gastight for it to be used as an electrolyte of the fuel cells.

31. A fuel cell generator including the fuel cell system of claim 29.

32. A fuel cell generator including the fuel cell system of claim 30.

33. A process for producing coated tubes for a fuel cell structure, the process comprising the steps of:
applying a coating to the tubes via a plasma spraying process; and
applying a vacuum slip casting process to the coated tubes so as to produce an altered coating including properties sufficient for the coated tubes to be used in a fuel cell.

34. A fuel system comprising tubes coated by the process of claim 33, wherein the coated tubes are configured in a bundled arrangement, the tubes being electrically connected in series.

35. A fuel cell generator including the fuel cell system of claim 34.

36. The process as claimed in claim 33, wherein the step of applying a coating to the tubes by a plasma spraying process includes using a plasma jet which has a defocusing action on an injected powder jet.

37. The process as claimed in claim 33, wherein the tubes are coated at least one of individually and jointly.

38. The process as claimed in claim 33, wherein the plasma spraying process is an LPPS thin-film process.

39. The process as claimed in claim 33, wherein the applied coating is impregnated using the vacuum slip casting process.

40. The process as claimed in claim 33, wherein the layers are sintered on the tubes.

41. The process as claimed in claim 33, wherein the tubes are pretreated prior to the coating, resulting in bonding of the coating to the tube surfaces.

42. The process as claimed in claim 33, wherein, after the coating, the tubes are assembled to form a bundle of the fuel cell structure.

43. The process as claimed in claim 33, wherein the fuel cell structure includes layers of tubular fuel cells, with flow passages integrated at least one of in and between the tubes.
